(19) United States
(12) Patent Application Publication
(10) Pub. No.: US 2007/0176982 A1
(43) Pub. Date: Aug. 2, 2007

(54) Inkjet actuator substrate having at least one non-uniform ink via

(75) Inventors: David G. King, Shelbyville, KY (US); George K. Parish, Winchester, KY (US); James H. Powers, Lexington, KY (US); Lucas D. Barkley, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/345,092

(22) Filed: Feb. 1, 2006

(51) Int. Cl. B41J 2/175

(52) U.S. Cl. 347/85

(57) ABSTRACT

Inkjet printheads and actuator chips, such as an inkjet printhead actuator chip having a substrate, ink vias formed in the substrate, and columnar arrays of actuators in operational communication with the ink vias. At least one of the ink vias has at least one of a different length, width and a via to via pitch than another one of the ink vias. Imaging devices for use with the printheads are also disclosed.

### BACKGROUND OF THE INVENTION

1.Field of the Invention

The present invention relates generally to inkjet printheads, and specifically, in an exemplary embodiment, to an inkjet printhead actuator chip substrate comprising a plurality of actuators and at least one non-uniform ink via residing in a thickness thereof.

2. Background of the Invention

The art of printing images with inkjet technology is relatively well known. In general, an image is produced by emitting ink drops from an inkjet printhead at precise moments such that they impact a print medium at a desired location. In one implementation, the printhead is supported by a movable print carriage within a device, such as an inkjet printer, and is caused to reciprocate/scan relative to an advancing print medium and emit ink drops at such times pursuant to commands of a microprocessor or other controller. The timing of the ink drop emissions corresponds to a pattern of pixels of the image being printed. Other than printers, familiar devices incorporating inkjet technology include fax machines, all-in-ones, photo printers, and graphics plotters, and the like.

Conventionally, an inkjet printhead includes access to a local or remote supply of ink(s), an actuator chip, a nozzle member (e.g., a nozzle plate) adjacent the actuator chip, and an input/output connector, such as a tape automated bond (TAB) circuit, for electrically connecting the actuator chip to the printer during use. The actuator chip, in turn, typically includes a plurality of actuators, such as thin film resistors (also sometimes referred to as “heaters”), piezoelectric elements, MEMs devices, and the like, on a substrate (e.g., but not limited to, silicon and ceramic substrates). One or more ink vias cut, etched or otherwise formed through a thickness of the substrate serve to fluidly connect the supply of ink(s) to the actuators. Typically, each ink via supplies ink from the “backside” of the actuator chip to the “front side” of the chip, which is where the actuators are located.

To print or emit a single drop of ink using heaters, for example, in one implementation, a heater(s) is supplied with a small amount of current to rapidly heat a volume of ink. This causes the ink to vaporize in a local ink chamber (between the heater and nozzle member) and eject a drop of ink through a nozzle(s) in the nozzle member towards the print medium.

In the past, manufacturers configured ink vias on a multiple ink via chip such that they were uniform in length, width and via to via pitch, with each conforming to the via having the most demanding corresponding flow rate. Typically, the ink vias are elongate in shape and have actuators on both sides thereof. The design and development of ink vias has been generally defined by, for example, address architecture, desired drop mass and desired drop patterns. For example, the length of an ink via has been substantially determined by the length of an array of actuators it supplies. For example, an actuator array consisting of 300 actuators on a 1/600^{th} of an inch pitch conventionally requires the ink via to be a minimum of a half inch in length. Typically, the ink via must also extend beyond the endmost “active” actuator (that is, an actuator intended to be used to cause ejection of ink, as opposed to a “dummy” actuator, which is not intended to be used to cause ejection of ink) in order to ensure adequate ink flow (e.g., to the endmost “active” actuators). As used throughout this description, the extension beyond the active actuator will be referred to as the “via extension”. The via extension is also dependent upon the width of the ink via. For example, the wider the ink via, the longer the via extension should be.

Conventionally, the width of an ink via has been generally determined by the flow rate of the corresponding ink. The flow rate has, in turn, been determined by the size of the drops to be ejected and the frequency (maximum) at which they are to be ejected. The size of the ejected drops, or drop size, and print frequency are defined by the address architecture of the actuator chip. In short, conventionally, an ink via must be wide enough to provide a free flow of ink to each active actuator, but not so wide as to entrap bubbles (which can lead to problems such as heater failure and/or starvation). Dual-sided ink vias (i.e., vias with actuators on opposing sides thereof) have a further conventional requirement placed on their width: the distance between a columnar array of nozzles supplied by actuators on one side of the via and a columnar array of nozzles supplied by actuators on an opposing side of the via should be an increment of the desired nominal printing grid for accurate drop placement. For example, if the desired printing grid has a horizontal resolution of 1200 dpi, such columnar arrays of nozzles should be spaced apart by a distance of an increment of 1/1200^{th} of an inch (e.g., 17/1200^{th} of an inch). This, in turn, can have an impact on the width of the via supplying the corresponding actuators.

The via to via pitch (i.e., the distance between centroids of adjacent vias) has been conventionally determined by both known mechanical rules and desired drop placement requirements. Typically, to reduce chip size, the pitch is as small as mechanically allowable. The nozzles corresponding to actuators supplied by the two vias should also be located such that their drops nominally correspond to the desired printing grid for correct drop placement. The pitch between such nozzle arrays is normally set to the next whole grid increment (e.g., 1200^{th} of an inch for a desired 1200 dpi horizontal resolution grid) beyond the mechanical limits, which can correspondingly affect the pitch of the vias supplying such nozzles (e.g., the greater the separation of the nozzle arrays, the wider the via to via pitch).

### SUMMARY OF THE INVENTION

In one embodiment, the present invention provides an inkjet printhead actuator chip having a substrate, ink vias formed in the substrate, and columnar arrays of actuators in operational communication with the ink vias. At least one of the ink vias has at least one of a different length, width and a via to via pitch than another one of the ink vias.

In another exemplary embodiment of the present invention, an actuator chip for an inkjet printhead is provided. The chip comprises a substrate, parallel columnar arrays of actuators adjacent the substrate, ink vias for supplying the actuators with ink, and a column of input terminals substantially perpendicular to said arrays. The ink vias are formed in the substrate. At least one of the ink vias has at least one of a length, a width, and a via to via pitch that is different from that of another one of the ink vias.

Still further, another exemplary embodiment includes an inkjet printhead having a substantially rectangular actuator chip with at least four substantially parallel ink vias. Two of the at least four substantially parallel ink vias have substantially the same lengths and widths. At least one of the other vias has a length and a width that is different from the lengths and the widths of the three vias.

Yet another exemplary embodiment involves an inkjet printhead having a substantially rectangular actuator chip with at least five substantially parallel ink vias. Four of the at least five substantially parallel ink vias have substantially the same lengths and widths, and at least one of the other vias has a length and a width that is different from the lengths and the widths of the four vias.

Printheads containing the actuator chip and imaging devices containing the printhead(s) are also disclosed.

Additional features and advantages of the invention are set forth in the detailed description which follows and will be readily apparent to those skilled in the art from that description, or will be readily recognized by practicing the invention as described in the detailed description, including the claims, and the appended drawings. It is also to be understood that both the foregoing general description and the following detailed description present exemplary embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the detailed description, serve to explain the principles and operations thereof. Additionally, the drawings and descriptions are meant to be merely illustrative and not limiting the intended scope of the claims in any manner.

### BRIEF DESCRIPTION OF THE DRAWINGS

FIG. 1 is a perspective view in accordance with one exemplary embodiment of the present invention of an inkjet printhead having an actuator chip with ink vias;

FIG. 2 is a perspective view in accordance with one exemplary embodiment of an inkjet printer;

FIG. 3A is a diagrammatic view of an inkjet actuator chip with four ink vias and two corresponding columns of actuators located on each side thereof constructed in accordance with an exemplary embodiment of the present invention;

FIG. 3B is a diagrammatic view of a portion of the inkjet actuator chip depicted in FIG. 3A, showing a staggered relationship of the actuators in one of the columns, with address and extended address references;

FIG. 3C illustrates an native addressing sequence/scheme that can be used with the inkjet actuator chip depicted in FIG. 3A, in accordance with an exemplary embodiment of the present invention;

FIG. 4 is a cross-sectional view of the inkjet actuator chip of FIG. 3A;

FIG. 5 is a diagrammatic view of an inkjet actuator chip with five ink vias and two corresponding columns of actuators located on each side thereof constructed in accordance with an exemplary embodiment of the present invention;

FIG. 6 is a diagrammatic view of a color portion of ink vias of an inkjet actuator chip with two corresponding columns of actuators located on each side thereof and a native drop pattern for an individual one of the columns, in accordance with an exemplary embodiment of the present invention;

FIG. 7 is a diagrammatic view of the native pattern of a single color portion of an actuator chip in accordance with an exemplary embodiment of the present invention;

FIG. 8 is a diagrammatic view of another native drop pattern of a single color portion of an actuator chip in accordance with an exemplary embodiment of the present invention;

FIG. 9 is a diagrammatic view of a native drop pattern of the color portion of an actuator chip with three or more ink vias constructed in accordance with an exemplary embodiment of the present invention;

FIG. 10 is a diagrammatic view of a color portion of an actuator chip with exemplary color polarity designations constructed in accordance with an exemplary embodiment of the present invention;

FIG. 11 is a diagrammatic view of an alternative drop pattern that can be produced by a single color portion of an actuator chip constructed in accordance with another exemplary embodiment of the present invention; and

FIG. 12 is a diagrammatic view in accordance with still another exemplary embodiment of the present invention of an alternative drop pattern of color portions of an actuator chip.

### DETAILED DESCRIPTION OF THE EXEMPLARY EMBODIMENTS

Reference will now be made in detail to exemplary embodiments of the invention, which are illustrated in the accompanying drawings. Whenever possible, the same reference numerals will be used throughout the drawings to refer to the same or like parts. Further, as used in the description herein and throughout the claims that follow, the meaning of “a”, “an”, and “the” includes plural reference unless the context clearly dictates otherwise. Also, as used in the description herein and throughout the claims that follow, the meaning of “in” includes “in” and “on” unless the context clearly dictates otherwise.

The present invention, in one embodiment, provides an actuator chip operable for use with an inkjet printhead of an inkjet printing system. However, it should be understood by those skilled in the art that a chip in accordance with the present invention may be applied to any printing system and/or imaging device wherein an actuator substrate is employed to facilitate the deposition of ink upon a medium. In an exemplary embodiment, an actuator chip includes a plurality of ink vias residing within a thickness of an actuator substrate, wherein at least one of the ink vias is non-uniform in at least one of length, width or pitch. The use of non-uniform ink vias can lead to reduced overall actuator chip size, thereby reducing the costs associated therewith. Moreover, the use of such non-uniform ink vias can afford for desired offsets of ink drop placement through the use of physical characteristics on the actuator chip (versus conventional methods such as the use of software algorithms—e.g., dithering algorithms). By providing offsets of drop placement, image processing time can be reduced and image quality optimized.

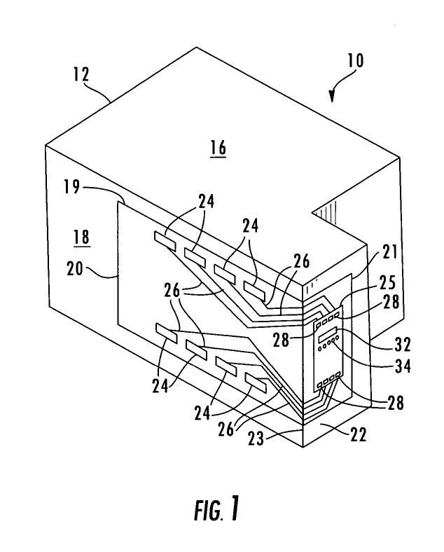

With reference now being made to the drawings and specifically to FIG. 1, an embodiment of an inkjet printhead is shown generally as 10. The printhead 10 in this embodiment has a housing 12. Its shape can vary and often depends upon the device that carries or contains the printhead 10. The housing 12 can have at least one compartment 16 internal thereto for holding an initial or refillable supply of ink. In one exemplary embodiment, the compartment 16 has a single chamber (not shown) and holds a supply of black ink, cyan ink, magenta ink or yellow ink. In other exemplary embodiments, the compartment 16 has multiple chambers, each containing a different ink. It will be appreciated, however, that while the compartment 16 is shown as locally integrated within a housing 12 of the printhead 10, it may alternatively connect to a remote source of ink and receive supply from a tube, for example, and/or be separable from the printhead 10.

Adhered to one surface 18 of the housing 12 is a portion 19 of a flexible circuit, such as a tape automated bond (TAB) circuit 20. The other portion 21 of the TAB circuit 20 is adhered to another surface 22 of the housing. In the illustrated embodiment, the two surfaces 18, 22 are perpendicularly arranged to one another about an edge 23 of the housing 12.

The TAB circuit 20 supports a plurality of input/output (I/O) connectors 24 thereon for electrically connecting a actuator chip 25 (and any of its attendant driving and logic circuitry) to an external device, such as a printer, fax machine, copier, photo-printer, plotter, all-in-one, etc., during use. Pluralities of electrical conductors 26 exist on the TAB circuit 20 to electrically connect and short the I/O connectors 24 to the input terminals (bond pads 28) of the actuator chip 25. Those skilled in the art know various techniques for facilitating such connections. For simplicity, FIG. 1 only shows eight I/O connectors 24, eight electrical conductors 26 and eight bond pads 28 but present day printheads have much larger quantities of the same and any number is equally embraced herein. Moreover, although FIG. 1 shows bond pads 28 that are aligned substantially parallel to an array 34 of actuators 36 (discussed below) and via 32, other embodiments might feature different alignments. For example, in an exemplary embodiment having five arrays of actuators, it may be beneficial to align the input terminals substantially perpendicular to the arrays and/or vias. Still further, those skilled in the art should appreciate that while such number of connectors, conductors and bond pads equal one another, actual printheads may have unequal numbers.

As previously alluded to, the actuator chip 25 generally includes a columnar array 34 of actuators 36 that can serve to cause ink to be selectively ejected through nozzles (not shown) in a nozzle member (not shown) towards a medium during use. The actuators 36 may embody thermally resistive elements (often referred to as “heaters”) formed as thin film layers on, for example, a silicon or ceramic substrate, piezoelectric elements, MEMs devices or the like. For simplicity, the actuators in columnar array 34 are shown in FIG. 1 as a column of five dots, but in practice, may include several hundred or thousand actuators. In general, vertically adjacent actuators/nozzles in a columnar array of the actuators 36/nozzles may be located in, e.g., 1/600^{th} of an inch increments along the longitudinal extent (or length) of an ink via 32. However, other pitches can be used in conjunction with the teachings of the present invention.

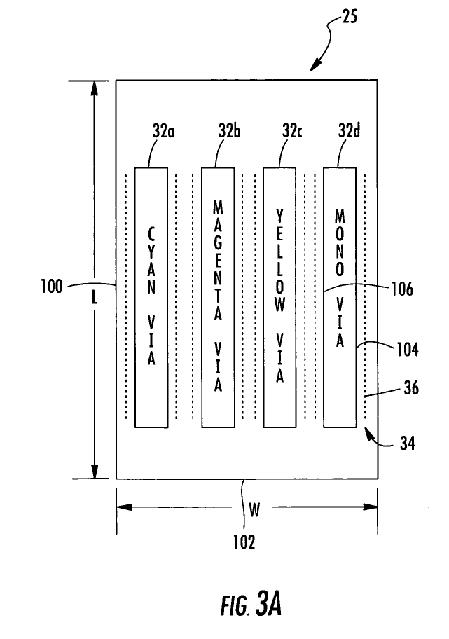

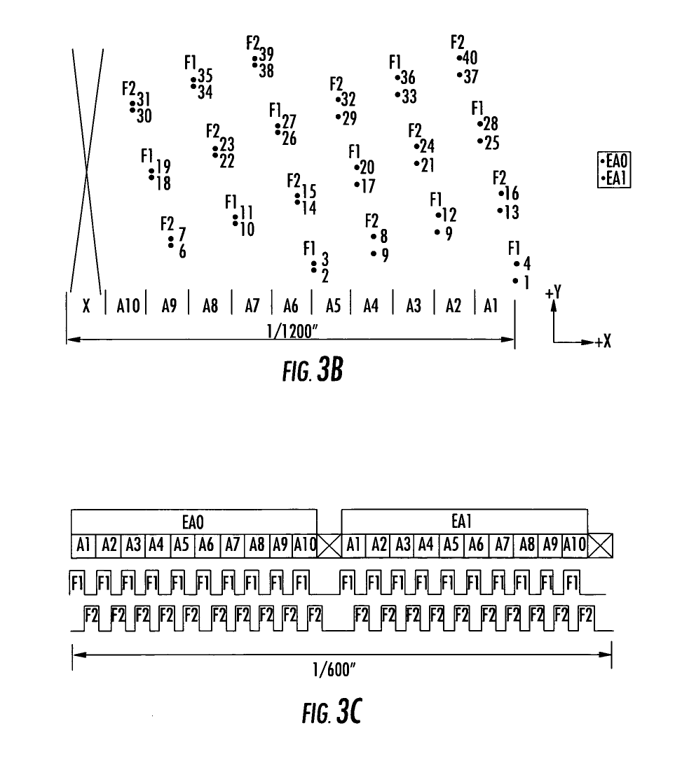

In an exemplary embodiment, a single actuator is used in conjunction with a single nozzle (e.g., the actuator and nozzle may share an axis, or an axis through the center of the actuator and an axis through the center of the nozzle might be offset from one another), and the nozzles are similarly grouped in a columnar array, although one of ordinary skill in the art will appreciate that the teachings of this invention can be expanded to embodiments where there are either multiple actuators corresponding to a single nozzle, or to embodiment where there are multiple nozzles corresponding to a single actuator (or combinations of any of the foregoing). Moreover, although array 34 has been described herein as columnar, it will be appreciated by those of ordinary skill in the art that, as shown in FIG. 3B, for scanning type printheads, the array may actually be comprised of several sub-columns (e.g., 20 subcolumns), with each of the subcolumns being spaced/staggered in a scan direction of the printhead to account for, for example, the fact that a printhead may be moving during use and to account for the time it takes to move through a sequence of addresses, as discussed later herein.

The actuator chip 25 also includes ink vias 32 formed (e.g., by cutting, blasting, or etching, for example) through a thickness of a substrate of the actuator chip 25 to fluidly connect a supply of ink to the actuators 36/nozzles. For example, each ink via 32 can be operable to supply ink from the backside of the actuator chip 25 to the front side of the chip 25, which is where the actuators 36 are located. To form the ink vias 32, many processes are known that cut, blast or etch the ink via 32 through a thickness of the substrate of the actuator chip 25. Some of such processes include grit blasting or etching, such as wet, dry, reactive-ion-etching, deep reactive-ion-etching, etc., or combinations thereof. In an exemplary embodiment of the invention, deep-reactive ion etching (DRIE) is used to etch the vias in a silicon substrate.

Among other alternatives, the nozzle member (not shown) may be attached with an adhesive or epoxy (e.g., such as a laser-ablated polyimide nozzle plate) or may be fabricated on the chip using one or more layers of material deposited thereon. In the case of the later alternative, nozzles may be formed therein using various photoimageable technologies and photoresist materials, as can be appreciated by one of ordinary skill in the art.

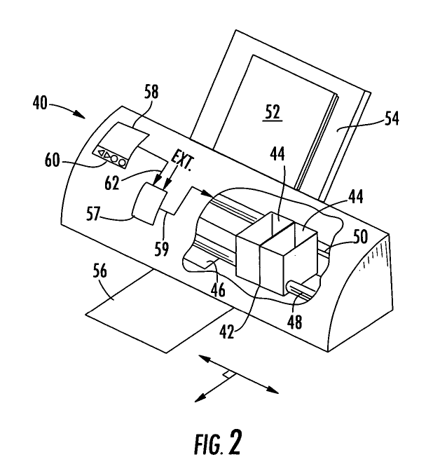

With reference to FIG. 2, an external device in the form of an inkjet printer containing the printhead 10 is shown generally as 40. The exemplary printer 40 includes a carriage (sometimes also referred to as a carrier) 42 having a plurality of slots 44 for containing one or more printheads 10. The carriage 42 reciprocates/scans (in accordance with an output 59 of a controller 57) along a shaft 48 above a print zone 46 by a motive force supplied to a drive belt 50 as is well known in the art. The reciprocation/scanning of the carriage 42 occurs relative to a print medium, such as a sheet of paper 52, that advances in the printer 40 along a paper path from an input tray 54, through the print zone 46, to an output tray 56.

While in the print zone, and as shown by the arrows, the carriage 42 reciprocates/scans in the Reciprocating Direction, which is conventionally generally perpendicular to the direction in which a medium, such as paper 52, is being advanced. Ink from compartment 16 (FIG. 1) is caused to be ejected by the actuator chip 25 in drops at times pursuant to commands of a printer microprocessor or other controller 57. The timing of the ink drop emissions corresponds to a pattern of pixels of the image being printed. Often times, such patterns become generated in devices operatively connected to the controller 57 (via Ext. input), but that reside external to the printer, such as, but not limited to, a computer, a scanner, a camera, a visual display unit, a personal data assistant, or other such devices. A control panel 58, having user selection interface 60, also accompanies many printers as an input 62 to the controller 57 to provide additional printer capabilities and robustness.

To print or emit a single drop of ink using a typical drop-on-demand thermal inkjet printhead, a heater (e.g., the dots of column 34, FIG. 1) is provided with a small amount of current (if addressed using the addressing architecture and pulsed) to rapidly heat a small volume of ink. This causes the ink to vaporize in a local ink chamber between the actuator and the nozzle member, and eject a drop of ink through the nozzle towards a print medium. The fire pulse required to emit such an ink drop may embody a single or a split firing pulse and is received at, or decoded on, the actuator chip via an input terminal (e.g., bond pad 28) from connections between the bond pad 28, the electrical conductors 26, the I/O connectors 24 and controller 57. Internal actuator chip wiring and/or logic conveys the fire pulse from the input terminal to the actuator being “fired.” Although there may be several actuators that receive a common fire pulse, only the one that has been addressed will be purposefully actuated. An exemplary addressing sequence for accomplishing the same is shown in FIG. 3C.

With reference now to FIGS. 3A and 4, an actuator chip 25 in accordance with one exemplary embodiment of the present invention is shown. Under modern wafer dicing practices, the individual actuator chip 25, if formed from a silicon wafer, may be severed from a larger multi-chip wafer and embodies a generally rectangular shape in its largest surface area. Further, the actuator chip 25 is provided with two long 100 and short ends 102, as shown. A representative lengthwise distance L of the actuator chip 25 might be about 17 millimeters (mm) while the widthwise W distance might be about 3 mm. However, it will be understood by those skilled in the art that other dimensions may be used. It will also be appreciated by those skilled in the art that the present invention illustrates and contemplates other actuator chip geometric shapes such as ovals, circles, squares, triangles, polygons or other shapes lending themselves to symmetrical or asymmetrical peripheries or regular or irregular boundaries.

As shown, the substrate of an actuator chip 25 generally includes a plurality of ink vias 32 residing in a thickness thereof and being operable for fluidly connecting a supply of ink to actuators/nozzles of the ink jet printhead 10. Each ink via 32 has a longitudinal extent (“length”) defined by a side thereof, such as sides 104, 106. In the exemplary embodiment shown, a columnar array, 34 of actuators 36 (with corresponding nozzles) exists along each side of the ink vias 32 for facilitating the ejection of the ink onto a medium. However, it will be understood by those skilled in the art that in other exemplary embodiments, the actuator arrays 34 may exist exclusively along one side of some or all of the vias 32.

The illustrated actuator chip 25 is provided with four ink vias 32a, 32b, 32c, 32d, respectively. The ink vias 32 are operable for supplying black ink (K), cyan ink (C), magenta ink (M) and/or yellow ink (Y) to the actuators 36/nozzles, thereby providing a CMYK configuration. However, it will be understood by those skilled in the art that any combination of inks may be used and the respective ink vias 32 may be configured accordingly. Unlike conventional actuator chips which have uniform ink vias, each of ink vias 32 may have a width, length, and/or via to via pitch that is different than that of the other ink vias 32.

As with conventional actuator chip and ink via designs, the length of the ink vias 32 are substantially determined by the length of the actuator arrays 34 existing along one or more of the respective sides, 104, 106. Further, each of the ink vias 32 are provided with an appropriate via extension. Meanwhile, the width of one or more of the ink vias 32a, 32b, 32c, 32d may be determined by the flow rate of the respective corresponding ink. As with conventional ink vias, the flow rate is determined by the size of the drops to be ejected and the frequency at which they are to be ejected. The size of the ejected drops, or drop size, and frequency is defined by the actuator addressing architecture. For example, if the addresses are cycled through at a faster rate, for a given flow rate, the ejection frequency will be faster and the drop size will likely decrease.

For dual-sided ink vias, the nozzles corresponding to active actuators on opposite sides thereof should be spaced apart (i.e., nozzle center to corresponding nozzle center) an increment of the desired printing grid for accurate drop placement. Meanwhile, the via to via pitch is determined by both known mechanical rules and drop placement requirements. In addition to flow rate and conventional drop placement requirements, the width and via to via pitch of, e.g., the CMY ink vias 32 of the exemplary embodiments described herein, are affected, at least in part, by a desired native color polarity scheme.

As will be understood by those skilled in the art, color polarity refers to the relationship between drop patterns capable of being formed with a particular type of ink in a single (unidirectional) scan of the printhead 10. For example, in an exemplary embodiment, it might be desirable to minimize the “white space” (i.e., the potentially uncovered space in between drop locations) associated with a “native” drop pattern. As used herein, the native drop pattern corresponds to the pattern of pixels in a printing grid that can be nominally addressed by drops ejected by the printhead when operating the printhead in accordance with its nominal design point. For example, a nominal design point may be a nominal scan speed (e.g., in inches per second) of the printhead and a particular addressing sequence (e.g., the sequence shown in FIG. 3C corresponds to the native mode of the exemplary embodiments disclosed herein). Referring to the addressing scheme depicted in FIG. 3C, this may mean actively cycling through each of addresses A1-A10, for each extended address EA0 and EA1, and pulsing fire groups F1 and F2 for each combination of address and extended address, while scanning the printhead at its nominal speed. By designing the printhead such that it incorporates color polarity into its native drop pattern, such as described herein, page coverage and color order effects, for example, can be optimized.

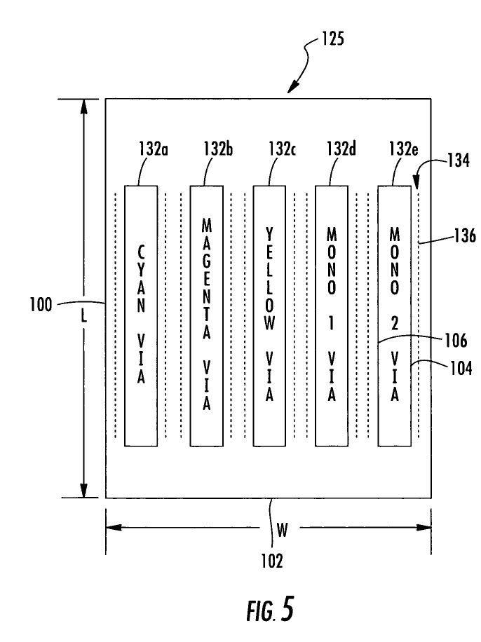

Referring now to FIG. 6, the CMY portion of an exemplary actuator chip 25 is shown. Each of the actuator arrays 34 (0, 1, . . . , 5)/nozzle arrays (not shown) might comprise a 600 dpi array of an equivalent number of active actuators, with the constituent actuators/nozzles horizontally staggered over 1/1200ths of an inch (see, e.g., FIG. 3B). When operated in its native mode (i.e., where the printhead is scanned at its nominal speed and using its nominal addressing sequence/scheme), in the illustrated exemplary embodiment, the entire addressing sequence shown in FIG. 3C is cycled through during the time it takes the printhead to move 1/600^{th} of an inch in the Reciprocating Direction. In such an exemplary embodiment operated in its native mode, each array of the chip 25 would have an associated native drop pattern as illustrated in FIG. 6 (which depicts the drop pattern, by indicating nominal drop centers, of one columnar array, such as array 0, fired over one addressing cycle while the printhead is operating in its native mode). As discussed from here further, references to drop patterns will implicitly be referring to the native drop patterns, unless indicated otherwise, either expressly or by context. In an exemplary embodiment, the even numbered actuator arrays 34 (0, 2, 4) can be aligned so that corresponding actuators/nozzles share horizontal rasters. Meanwhile, the odd numbered actuator arrays 34 (1, 3, 5)/nozzles can also be aligned, but offset vertically by one raster compared to the even arrays, effectively doubling the vertical resolution.

Further, by spacing, e.g., cyan nozzle/actuator arrays 0 and 1 an even increment of 1/1200^{th} of an inch apart (e.g., 18/1200ths from nozzle center to corresponding nozzle center), the native drop pattern shown in FIG. 7 can be produced. In FIG. 7, the dots 108 (lighter shaded circle) identify drops that can be placed by actuator array 0 and the dots 110 (darker shaded circle) identify drops that can be placed by actuator array 1, together forming a vertical “couplet” pattern (which may also sometimes be referred to as a “doublet” pattern), as shown in FIG. 7. As can be seen from inspection of this figure, such a couplet pattern includes “white space” between vertically and horizontally adjacent couplets.

Conventionally, the other arrays on the chip would be configured such that each type of ink (e.g., C, M, and Y) would all share the same drop pattern, and would be configured such that these drop patterns would nominally overlie one another (sometimes referred to being “in phase”), such that if the printhead would be operated to actually produce each drop pattern during a single unidirectional scan of the printhead, the drops of each type of ink (e.g., CMY) would all nominally land on top of one another. Because of the fixed relationship of the locations of the arrays corresponding to the different types of ink, the hue of such a combined drop can shift depending on in which direction the printhead is being scanned. For example, if scanned left-to-right, the printhead might first lay down a cyan drop, then cover that with a magenta drop, which would then be covered by a yellow drop. Meanwhile, if scanned right-to-left, the order would be reversed, such that a yellow drop would be covered by a magenta drop, which would in turn be covered by a cyan drop. As can be appreciated by one of ordinary skill in the art, the difference in the order of how these combined drops were formed typically leads to variations (or “shifts”) in hue.

In an exemplary embodiment of the present invention, an actuator chip includes cyan and magenta nozzle/actuator arrays, and cyan and magenta ink vias sized and situated to respectively produce cyan and magenta ink drop patterns that are shifted relative to one another by, e.g., 1/1200^{th} of an inch horizontally (instead of being in phase, as was conventional). This, in effect, polarizes the cyan and magenta drop patterns with respect to one another. Further, an actuator chip according to an exemplary embodiment of the present invention also includes nozzle/actuator arrays and a yellow ink via sized and situated such that the yellow ink drop pattern is shifted vertically 1/1200^{th} of an inch relative to the cyan and magenta drop patterns. This vertical shift is achieved by moving one of the yellow arrays by 1/1200^{th} horizontally away or towards the other yellow array. This in turn drives a different via width for the yellow ink.

For example, the aforementioned cyan/magenta color polarity can be accomplished by having magenta and cyan nozzle/actuator arrays 34 (e.g., array 0 and array 2, and array 1 and array 3) that are spaced apart by an odd increment of 1/1200^{th} of an inch (e.g., 71/1200^{th} from nozzle center to corresponding nozzle center). This, in turn causes the drop pattern of magenta ink to have a 1/1200^{th} of an inch offset from the drop pattern of cyan ink, effectively placing these patterns 180 degrees out of phase horizontally. In this case, as shown by example in FIG. 9, in a single unidirectional pass during which cyan drops 108 and 110 are ejected, magenta drops 116 and 118 (e.g., from columns 2 and 3) can be ejected into the white space of the cyan arrays' drop pattern.

Utilizing arrays to accomplish such combined drop patterns can help improve the effects of drop misdirection and can improve single pass color saturation (e.g., compared to utilizing arrays that have identical drop patterns that are in phase, as was conventional). Also, as can be understood from the previous discussion, since the drop patterns are now 180 degrees out of phase, the hue shift issue caused by the differences in ordering of the colorant drops (between different directions of scans) can also be significantly reduced (e.g., the different inks will mix much less than if the drop patterns were in phase).

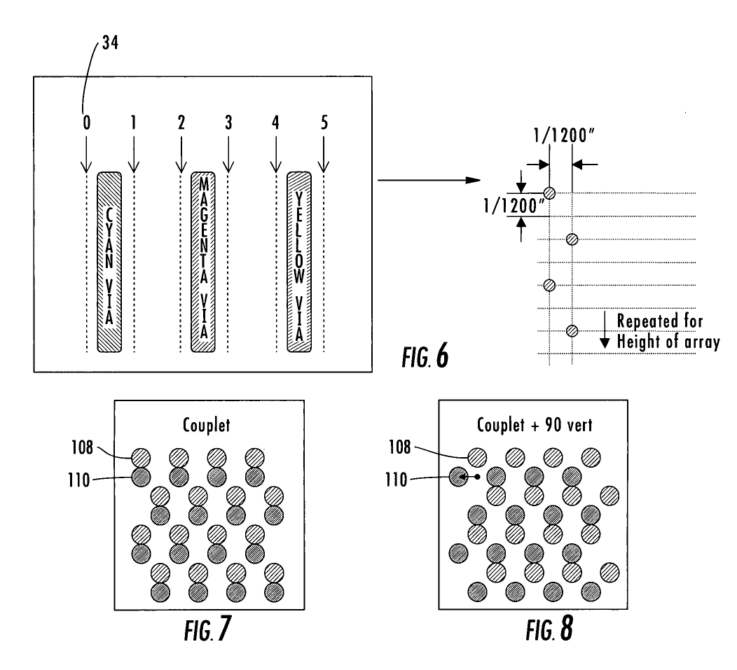

Further still, as shown in FIG. 8, if the horizontal spacing between arrays supplied with a particular ink is changed, a different drop placement pattern for that ink can be achieved. Specifically, FIG. 8, shows a drop placement pattern (sometimes referred to herein as a couplet+vertical 90 degrees pattern) that can be produced if, e.g., nozzle/actuator array 1 was effectively shifted 1/1200^{th} of an inch towards nozzle/actuator array 0. As with FIG. 7, the cyan drops 108 are deposited by nozzle/actuator array 0 and the cyan drops 110 are deposited by nozzle/actuator array 1. As depicted, the same general couplet pattern is still provided for cyan, but the pattern is now shifted vertically by 90 degrees with respect to the original pattern.

With reference to the embodiment previously discussed above involving a magenta/cyan polarity, and referring again to FIG. 9, in an exemplary embodiment of the present invention, nozzle arrays corresponding to actuator arrays 4 and 5 (yellow) are shifted such that the yellow drop pattern (as opposed to the cyan drop pattern) is vertically shifted as discussed above with respect to FIG. 8 (which dealt with cyan). For example, by comparison to the spacing between the cyan and magenta arrays, such a vertical shift in the yellow drop pattern can be achieved by decreasing the horizontal spacing between the yellow nozzle arrays (e.g., corresponding to arrays 4 and 5 across the yellow ink via 32c) by 1/1200^{th} of an inch (relative to the corresponding spacing between the cyan and magenta arrays). Accordingly, a narrower yellow ink via 32c can then be used (in comparison to the cyan and magenta ink vias, for example), potentially reducing the size of the actuator chip.

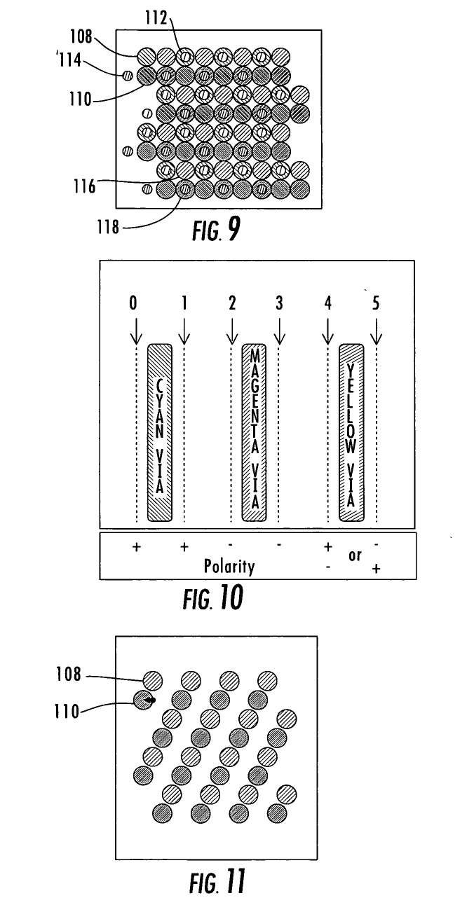

Utilizing such a drop pattern with the polarized cyan and magenta drop patterns effectively places the drop pattern of one of the yellow arrays in phase with the drop pattern of one of the cyan arrays, while placing the drop pattern of the other yellow array in phase with the drop pattern of one of the magenta arrays. Another way to depict this relationship is shown in FIG. 10, wherein the array layout with the corresponding polarity is set forth. This can help “balance” the yellow response of the printhead. In particular, by contrast, if the yellow drop pattern was fully in phase with one drop pattern (e.g., cyan), but fully out of phase with the other (e.g., magenta), the gamut would shift in one direction. Moreover, such a combined drop pattern can improve the hue shift issue with respect to color order by reducing the total number of possible CY and MY drop combinations.

While the color polarity scheme set forth herein is exemplary, it will be appreciated by those skilled in the art that different color polarity schemes may also be used. Accordingly, the size and situation of the ink vias 32 may also vary. For example, in an alternative exemplary embodiment, an actuator chip may have two columns of a single color shifted with respect to each other by less than the corresponding resolution of the grid, e.g., less than 1/1200^{th} of an inch (e.g., 1/2400^{th} from nozzle center to corresponding nozzle center). By using such a color polarity scheme, diagonal drop patterns, as opposed to couplet drop patterns, can be created, which may be beneficial in some printing cases.

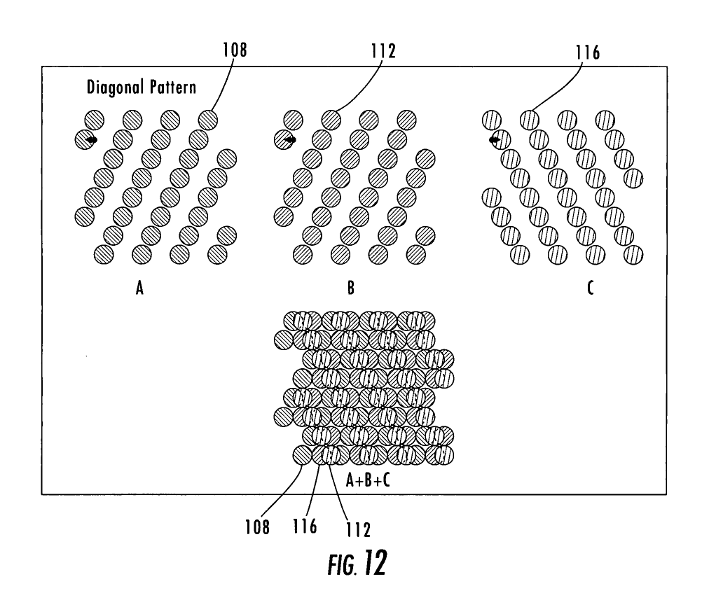

For example, FIG. 11 illustrates a diagonal drop pattern of a cyan portion of the actuator chip, wherein drops 108 represent the drop pattern of array 0 and drops 110 represent the drop pattern of array 1. Still further, by using various combinations of the described drop patterns and color polarity schemes, an even coverage CMY combined drop pattern may be produced, as shown in FIG. 12.

Referring back to FIGS. 3-4, in an exemplary embodiment of the present invention, a K (mono) via 32d, and CMY ink vias, 32a, 32b, 32c, respectively, for example, can also have different flow rates under the print architecture. For example, the CMY ink vias 32a, 32b, 32c, might be designed to allow for 16 simultaneous fires of 4 pL drops at a maximum frequency of 24 kHz, whereas the K ink via 32d might be designed to allow for 32 simultaneous fires of 12 pL drops at a frequency of 18 kHz. In accordance with such an embodiment, the K ink via 32d might have a higher requirement for flow than the CMY ink vias. Therefore, its ink via might be wider to accommodate the higher ink flow without trapping air. For example, the K ink via 32d might be about 388 um wide versus roughly 216 um wide CMY ink vias.

The ink vias 32 might also differ in length. For example, if each via 32 has 640 actuators in substantially the same orientation, the columnar arrays 34 might not necessarily lead to a difference in via length. However, via length extension can be partly driven by via width. In an exemplary embodiment, the cyan and magenta vias 32a, 32b might be of the same width and length. If the yellow via 32c, however, is 1/1200^{th} of an inch narrower (e.g., because it is being polarized with respect to cyan and magenta), its length extension might be correspondingly shorter than that of the cyan and magenta vias 32a, 32b. Similarly, if a K via 32d, for example, is considerably wider than any of the CMY vias 32a, 32b, 32c, it may have a longer via extension. Accordingly, by utilizing non-uniform ink vias 32, an actuator chip 25 can support different print architectures, such as for black (mono) and CMY (color) inks.

Referring now to Table 1, exemplary (box) dimensions and via to via pitches of the ink vias 32 of an exemplary embodiment in accordance with FIGS. 3-4 is shown. For purposes of the discussion herein, a “via box” can be considered a bounding box for the front-side opening of a via. Generally, one of ordinary skill in the art will appreciate that a via should not extend past, or make contact with, the via box. Typically, the via box defines the area of the chip where, e.g., thin-film layers used to form devices on an actuator chip will be stepped-down to help with sealing such devices from the ingression of ink. In the exemplary embodiments presented below, the width and length dimensions of the respective ink via can be considered to substantially correlate to the x dimension of the respective via box.

TABLE 1

| | Ink Via Centroids | | | | |
|---|---|---|---|---|---|
| | (relative to an x- | | Via Box | | |
| | and y- axis) | | Dimensions | | Via to Via Pitch |
| | x(μm) | y(μm) | x(μm) | y(μm) | x(μm) |
| Cyan | −2497.6 | 0 | 246 | 13790 | to M = 1502.8 |
| Magenta | −994.8 | 0 | 246 | 13790 | to Y = 1492.2 |
| Yellow | 497.4 | 0 | 226 | 13775 | to K = 1896.3 |
| Black | 2393.7 | 0 | 418 | 13910 | to Y = 1896.3 |

As shown in Table 1 and FIG. 4, while the exemplary actuator chip 25 is provided with four ink vias 32 (cyan, magenta, yellow and black, respectively), two of those vias are substantially uniform in length (see, e.g., the y dimension of cyan and magenta) and width (see, e.g., the x dimension of cyan and magenta). Meanwhile, the length and width of the other two vias vary. Moreover, the via to via pitch is not uniform.

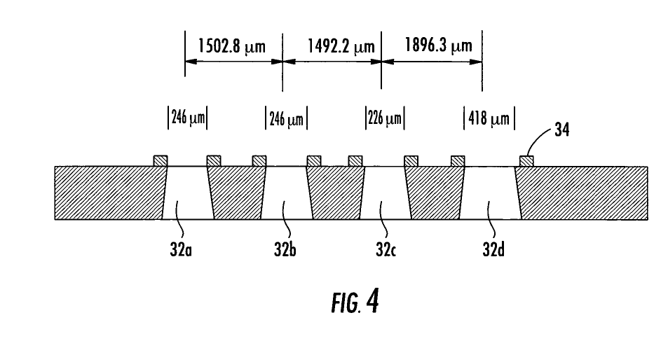

With reference now to FIG. 5, an actuator chip 125 in accordance with another exemplary embodiment of the present invention is shown. As shown, the actuator chip 125 generally includes a plurality of ink vias 132. Further, the actuator chip 125 includes columnar arrays 134 of actuators 136 along each side of the ink vias 132. Unlike the exemplary embodiment of FIG. 3-4, two black (mono) ink vias 132d, 132e are provided in this embodiment, with each such via being provided with 320 (active) actuators on both sides. In such an embodiment, each of the black ink vias 132d, 132e might be designed to allow for 16 simultaneous fires of 5 pL drops at a maximum frequency of 24 kHz, thereby enabling them to use the same addressing architecture as that used with the CMY vias. In such an embodiment, the fluidic requirements of the black ink vias 132d, 132e might be similar enough to the CM ink vias 132a, 132 b to allow for the same via width to be used with all four of these vias, which then allows for the same via length to be used with all four.

Nevertheless, if it is desired to polarize yellow as set forth with respect to the embodiment depicted in FIG. 9, for example, the yellow ink via 32c might be made narrower, and therefore shorter, than the other vias 132a, 132b, 132d, 132e. Accordingly, the chip size might also be reduced.

Referring now to Table 2, exemplary ink via (box) dimensions that might be associated with an exemplary embodiment, such as that depicted in FIG. 5, are shown.

TABLE 2

| | |
|---|---|
| Ink Via Centroids | |
| (with respect | |
| to an x- and | Via Box |
| y-axis) | Dimensions |

| | x(μm) | y(μm) | x(μm) | Y(μm) |
|---|---|---|---|---|
| Cyan | −2860.5 | 0 | 242 | 13716 |
| Magenta | −1442.3 | 0 | 242 | 13716 |
| Yellow | −55.9 | 0 | 222 | 13701 |
| Black 1 | 1439.3 | 0 | 242 | 13716 |
| Black 2 | 2857.5 | 0 | 242 | 13716 |

As shown in Table 2, while the exemplary actuator chip 125 might be provided with five ink vias 32 (cyan, magenta, yellow, black (mono) 1 and black (mono) 2, respectively), four of those vias are substantially uniform in length (e.g., y dimension) and width (e.g., x dimension), whereas the other (yellow) does not conform. Nevertheless, as can be appreciated from the centroid positions, the via to via pitch is still non-uniform. As can be appreciated, this may be implemented to afford for native color polarity and/or couplet/doublet (or other patterns, such as quartets, for example) printing, for example. As a particular example, chip 125 might be configured such that C, M, Y and both K arrays have native couplet drop patterns (or the like).

It will be apparent to those skilled in the art that various modifications and variations can be made to the present invention without departing from the spirit and scope of the invention. Thus, it is intended that the present invention cover all conceivable modifications and variations of this invention, provided those alternative embodiments come within the scope of the appended claims and their equivalents.

What is claimed is:

1. An inkjet printhead actuator chip, comprising:
a substrate;
ink vias formed in the substrate, at least one of said ink vias having at least one of a different length, width and a via to via pitch than another one of the ink vias;
columnar arrays of actuators in operational communication with the ink vias.

2. The actuator chip of claim 1, wherein said arrays exist along at least two opposing sides of said ink vias.

3. The actuator chip of claim 1, wherein each of said arrays exists exclusively along a single side of a respective corresponding one of said ink vias.

4. The actuator chip of claim 1, wherein the via to via pitch of at least one of the ink vias is at least partially defined by a color polarity scheme.

5. The actuator chip of claim 1, wherein the width of at least one of the ink vias is at least partially defined by a color polarity scheme.

6. The actuator chip of claim 1, wherein the ink vias comprise a cyan ink via, a magenta ink via, a yellow ink via and a black ink via, said cyan and magenta ink vias having substantially the same length and width.

7. The actuator chip of claim 1, wherein the ink vias comprise a cyan ink via, a magenta ink via, a yellow ink via, a first black ink via and a second black ink via, said cyan, magenta, first black and second black ink vias having substantially the same lengths and widths.

8. An actuator chip for an inkjet printhead, comprising:
a substrate;
parallel columnar arrays of actuators adjacent the substrate;
ink vias for supplying the actuators with ink, said ink vias being formed in said substrate, at least one of the ink vias having at least one of a length, a width, and a via to via pitch that is different from that of another one of the ink vias; and
a column of input terminals being substantially perpendicular to said arrays.

9. The actuator chip of claim 8, wherein said actuators comprise thermal resistive actuator elements.

10. An inkjet printhead comprising a substantially rectangular actuator chip having at least four substantially parallel ink vias, two of said at least four substantially parallel ink vias having substantially the same lengths and widths, and at least one of the other vias having a length and a width that is different from the lengths and the widths of the three vias.

11. An inkjet printhead, comprising a substantially rectangular actuator chip having at least five substantially parallel ink vias, four of said at least five substantially parallel ink vias having substantially the same lengths and widths, and at least one of the other vias having a length and a width that is different from the lengths and the widths of the four vias.

12. The inkjet printhead of claim 11, wherein the at least five ink vias comprise a cyan ink via, a magenta ink via, a yellow ink via, a first black ink via, and a second black ink via, wherein the yellow ink via has a length and a width that is different from the lengths and the widths of the cyan ink via, the magenta ink via, the first black ink via, and the second black ink via.

13. The inkjet printhead of claim 12, wherein each of the vias has a via centroid, the magenta ink via centroid being separated from the cyan ink via centroid by about 67/1200^{th} of an inch, the yellow ink via centroid being separated from the magenta ink via centroid by about 65.5/1200^{th} of an inch, and the first black ink via centroid being separated from the second black via centroid by about 67/1200^{th} of an inch.

14. The inkjet printhead of claim 13, wherein the width of the yellow ink via is about 20 micrometers less than the width of any of the other vias, and the length of the yellow ink via is about 15 micrometers less than the length of any of the other vias.

15. The inkjet printhead of claim 12, further comprising a first columnar array of actuators adjacent a first side of each of the ink vias, and a second columnar array of actuators adjacent a second side of each of the ink vias.

16. The inkjet printhead of claim 15, wherein the first columnar array of actuators adjacent the yellow ink via are separated from the second columnar array of actuators adjacent the yellow ink via by a distance that is about 1/1200^{th} of an inch less than the distance between the first and second columnar arrays that are adjacent to any of the other vias.
